(19) United States
(12) Patent Application Publication
(10) Pub. No.: US 2013/0014905 A1
(43) Pub. Date: Jan. 17, 2013

(54) FILM PEELING APPARATUS AND FILM PEELING METHOD

(71) Applicants: Yoshiyuki NAKAZAWA, Kyoto-shi (JP); Hirofumi MASUHARA, Kyoto-shi (JP); Koji ANDO, Kyoto-shi (JP)

(72) Inventors: Yoshiyuki NAKAZAWA, Kyoto-shi (JP); Hirofumi MASUHARA, Kyoto-shi (JP); Koji ANDO, Kyoto-shi (JP)

(21) Appl. No.: 13/547,468

(22) Filed: Jul. 12, 2012

(30) Foreign Application Priority Data
Jul. 14, 2011 (JP) 2011-155691

(51) Int. Cl. B32B 38/10

(52) U.S. Cl. 156/712; 156/753

(57) ABSTRACT

An ultrashort pulsed laser beam, the fluence of which on an interface BF is set to be larger than a substrate processing threshold and smaller than a film processing threshold, is irradiated to the interface BF via a thin film F. Thus, in a laser irradiated portion of the interface BF, the substrate W is selectively processed, bonding between the substrate and the thin film F is reduced and the thin film F is peeled.

### CROSS REFERENCE TO RELATED APPLICATION

The disclosure of Japanese Patent Application No. 2011-155691 filed on Jul. 14, 2011 including specification, drawings and claims is incorporated herein by reference in its entirety.

### BACKGROUND OF THE INVENTION

1. Field of the Invention

The invention relates to a film peeling apparatus and a film peeling method for removing films formed on various substrates such as semiconductor wafers.

2. Description of the Related Art

A production process of electronic components such as semiconductor devices and liquid crystal display devices sometimes includes a process of removing a film formed on a substrate in a predetermined pattern. For example, an apparatus for removing a thin film adhering to a peripheral end portion (bevel portion) of a surface of a substrate is disclosed in JP-A-2009-21339. In the film removing apparatus, a substrate is arranged on a spin chuck in a horizontal posture where a surface is facing upward, and a facing member is arranged to face the substrate surface at a position above the substrate. Then, a nozzle is inserted into a nozzle insertion hole provided in a peripheral end portion of the facing member. A chemical solution such as an etching solution is supplied from the nozzle toward the peripheral end portion of the rotating substrate surface, whereby the thin film is etched and removed from the peripheral end portion of the surface. In the way, the thin film is selectively removed from the substrate surface by a predetermined width from an end edge of the substrate toward the center of the substrate.

### SUMMARY OF THE INVENTION

Since films are removed by a chemical solution in such a conventional apparatus, a chemical solution used differs depending on the type of films in many cases and chemical solutions corresponding to the types of films to be removed need to be prepared. If a film to be removed is a multi-layer film, nearly as many chemical supplying processes as the types of films forming the multi-layer film are necessary. After a treatment with the chemical solution, a rinsing process with pure water is necessary to rinse off the chemical solution. Such a series of processes are all wet processes, which is one of factors which increase production cost and also a factor which burdens the environment.

An object of the present invention is to provide a technology capable of removing a film from a substrate without using a chemical solution to reduce production cost and environmental burden.

A film peeling apparatus according to an aspect the invention comprises: a holder that holds the substrate having a film; and an irradiator that irradiates an ultrashort pulsed laser beam to an interface between the substrate and the film via the film, thereby processing the substrate and peeling the film, wherein the fluence of the ultrashort pulsed laser beam to be irradiated to the interface is larger than a processing threshold fluence necessary to process the substrate by the ultrashort pulsed laser beam and smaller than a processing threshold fluence necessary to process the film by the ultrashort pulsed laser beam.

A film peeling method according to an aspect the invention peels a film formed on a substrate. The method comprises: irradiating an ultrashort pulsed laser beam to an interface between the substrate and the film via the film, wherein a fluence of the ultrashort pulsed laser beam is larger than a processing threshold fluence necessary to process the substrate by the ultrashort pulsed laser beam and smaller than a processing threshold fluence necessary to process the film by the ultrashort pulsed laser beam.

In the apparatus and method, the ultrashort pulsed laser beam is irradiated to the interface between the substrate and the film via the film. The fluence (value obtained by dividing energy of the pulsed laser beam by an irradiation area) of the ultrashort pulsed laser beam is set as follows. That is, the fluence of the ultrashort pulsed laser beam is set at a value larger than the processing threshold fluence necessary to process the substrate by the ultrashort pulsed laser beam and smaller than the processing threshold fluence necessary to process the film by the ultrashort pulsed laser beam. Thus, in a part of the interface irradiated by the ultrashort pulsed laser beam, the substrate is selectively processed, bonding between the substrate and the film in the interface part is reduced and the film is peeled.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTIONS OF THE DRAWINGS

FIG. 1 is a diagram showing one embodiment of a film peeling apparatus according to the present invention;

FIG. 2 is views diagrammatically showing film peeling movements by the film peeling apparatus of FIG. 1;

FIG. 3A is a picture showing a surface before a silicon oxide film on a silicon substrate was peeled;

FIG. 3B is a picture showing the surface after the silicon oxide film on the silicon substrate was peeled;

FIGS. 4A and 4B are pictures showing interfaces of a peeled portion and a non-removed portion when the silicon oxide film on the silicon substrate was peeled;

FIGS. 5A and 5B are pictures showing interfaces of a peeled portion and a non-removed portion when the silicon nitride film on the silicon substrate was peeled; and

FIGS. 6A and 6B are pictures showing interfaces of a peeled portion and a non-removed portion when the silicon carbide film on the silicon substrate was peeled.

### DETAILED DESCRIPTION OF THE PREFERRED EMBODIMENTS

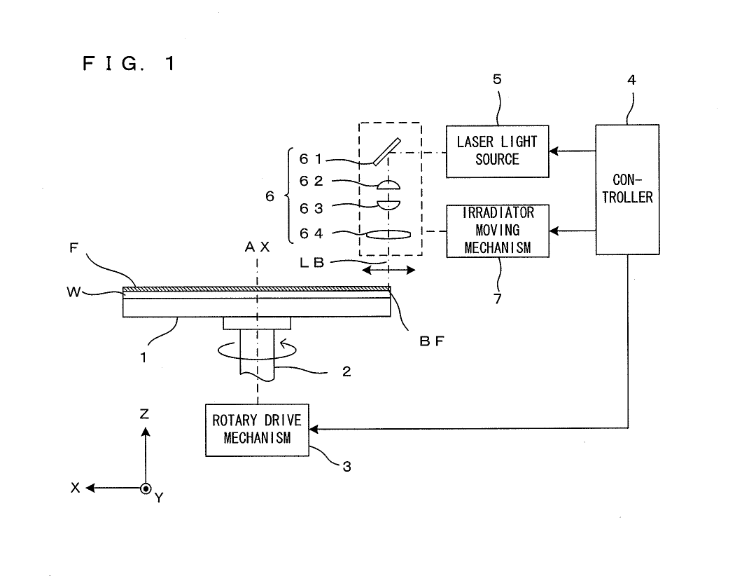

FIG. 1 is a diagram showing one embodiment of a film peeling apparatus according to the present invention. The film peeling apparatus is designed to remove a part of a thin film F formed on a surface of a substrate W adhering to a peripheral end portion (bevel portion) of the surface of the substrate W by an ultrashort pulsed laser beam LB and configured as follows. The film peeling apparatus includes a spin chuck 1 for holding the substrate W by a vacuum suction method. The spin chuck 1 is rotatable about an axis of rotation AX, and a plurality of suction holes (not shown) are provided on the upper surface thereof. The underside of the substrate W placed on the upper surface of the spin chuck 1 is vacuum-sucked and held by a negative pressure given to the respective suction holes from an unillustrated negative pressure source. Although the spin chuck 1 functions as a “holder” of the present invention as just described, a method for holding the substrate W by the spin chuck 1 is not limited to the vacuum suction method and a conventionally known method, e.g. a mechanical chuck method may be adopted.

A rotational support shaft 2 extends in the axis of rotation AX. An upper end portion of the rotational support shaft 2 is connected to the lower surface of the spin chuck 1. A rotary driving mechanism 3 is connected to a lower end portion of the rotational support shaft 2, and the spin chuck 1 rotates about the axis of rotation AX by driving the rotary driving mechanism 3 in accordance with an operation command from a controller 4 for controlling the entire apparatus. In the embodiment, the rotary driving mechanism 3 functions as a “rotary drive” of the present invention and can rotate the substrate W held on the spin chuck 1 about the axis of rotation AX at various circumferential speeds in response to a control command from the controller 4.

In the embodiment, a laser light source (e.g. “IFRIT” produced by Cyber Laser Inc.) 5 for outputting a femtosecond laser beam LB is used as a generation source of an ultrashort pulsed laser beam LB. The femtosecond laser beam LB output in a horizontal direction from the laser light source 5 is irradiated to the substrate W held on the spin chuck 1 by an irradiator 6.

The irradiator 6 includes a mirror 61 for reflecting the femtosecond laser beam LB and guiding it downwardly, two cylindrical lenses 62, 63 for shaping the femtosecond laser beam LB reflected by the mirror 61, and a condenser lens 64 for focusing the femtosecond laser beam LB shaped by these cylindrical lenses 62, 63 on an interface between the substrate W and a thin film F. In the embodiment, the femtosecond laser beam LB is shaped to have a desired beam shape and focused on the interface to adjust an irradiated beam size on the interface, i.e. an irradiation area. Accordingly, the fluence of the ultrashort pulsed laser beam LB on the interface is increased by the irradiator 6. Since the film is peeled by processing only the substrate W with the ultrashort pulsed laser beam LB as described later in the embodiment, the fluence of the ultrashort pulsed laser beam LB on the interface is controlled by the controller 4. In particular, the fluence is set a value larger than a processing threshold fluence necessary to process the substrate W by the ultrashort pulsed laser beam LB (hereinafter, referred to as a “substrate processing threshold”) and smaller than a processing threshold fluence necessary to process the thin film F by the ultrashort pulsed laser beam LB (hereinafter, referred to as a “film processing threshold”).

The irradiator 6 is provided to be movable in a radial direction X of the substrate W with respect to the axis of rotation AX and mechanically connected to an irradiator moving mechanism 7. Thus, when the irradiator moving mechanism 7 operates based on a movement command from the controller 4, the irradiator 6 moves in the radial direction X. In the way, the irradiator 6 moves in the radial direction X relative to the substrate W and can irradiate the ultrashort pulsed laser beam LB to a position distant from the center of rotation of the substrate W by a predetermined distance in the radial direction of the substrate W. While film peeling is not performed, the irradiator moving mechanism 7 moves the irradiator 6 to a position distant from the spin chuck 1 in the radial direction X. This allows that interference of the irradiator 6 with the substrate W can be prevented when the substrate W is carried to and from the spin chuck 1. As just described, in the embodiment, the irradiator moving mechanism 7 functions as a “mover” of the present invention.

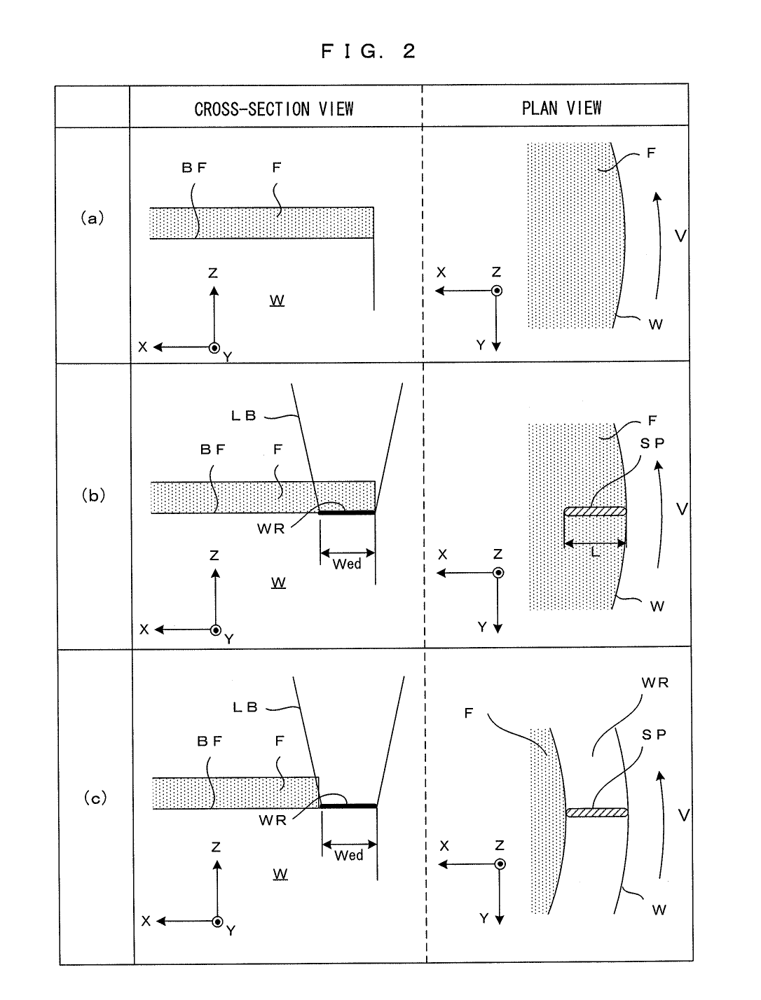

Next, the operation of the thus configured film peeling apparatus will be described. FIG. 2 is views diagrammatically showing film peeling movements by the film peeling apparatus of FIG. 1. A left column of FIG. 2 is sectional views of an end edge portion of the surface of the substrate W and a right column of FIG. 2 is plan views of the end edge portion of the surface, wherein a pearskin finished part indicates the thin film F formed on the surface of the substrate W. After the substrate W having the thin film F formed on the entire substrate surface is conveyed to the film peeling apparatus and then suction-held on the upper surface of the spin chuck 1, the controller 4 controls the entire apparatus to peel the thin film F by a predetermined width Wed from the end edge of the substrate W toward the center of rotation (left side in FIG. 2).

When suction-holding of the substrate W by the spin chuck 1 is completed, the controller 4 gives a drive command to the rotary driving mechanism 3 so as to rotate the spin chuck 1. Accordingly, the substrate W starts rotating about the axis of rotation AX while being held in the horizontal posture (field (a) in FIG. 2). Then the circumferential speed of the substrate W becomes stable and reaches a predetermined circumferential speed V [mm/s]. At the time, the controller 4 gives a movement command to the irradiator moving mechanism 7 to move the irradiator 6 to a position above a peripheral edge portion of the surface of the substrate W and gives a turn-on command to the laser light source 5 to cause the laser light source 5 to output an ultrashort pulsed laser beam LB.

In the embodiment, the irradiator 6 includes the two cylindrical lenses 62, 63 and a beam diameter of the ultrashort pulsed laser beam LB in the direction X is adjusted by the lens pair. The ultrashort pulsed laser beam LB having the adjusted beam diameter is focused on an interface BF between the substrate W and the thin film F via the thin film F by the condenser lens 64, whereby a linear, flat or elliptical beam spot extending a predetermined length L in the radial direction X of the substrate W is formed on the interface BF as shown in a field (b) of FIG. 2. Here, whereas the length L is set to coincide with the width Wed, a length in a direction Y perpendicular to the radial direction X is reduced. This allows reducing the area of a focused spot SP of the laser beam LB irradiated to the interface BF and adjusting the fluence of the ultrashort pulsed laser beam LB on the interface BF. That is, the fluence is adjusted to be larger than the substrate processing threshold and smaller than the film processing threshold. Thus, if the ultrashort pulsed laser beam LB is irradiated to the interface BF via the thin film F as described above, the substrate W on the interface BF is selectively processed without processing the thin film F. As a result, a bonding force between the substrate W and the thin film F on the interface BF decreases. Note that, in FIG. 2, a processing region WR processed in the way is shown by thick line.

The irradiation of the ultrashort pulsed laser beam LB is continued at least while the substrate W is rotated one turn or more and the processing region WR spreads over an end edge portion of the substrate W. Since the bonding force of the thin film F to the substrate W is reduced in the processing region WR, the thin film is selectively peeled from the processing region WR during the irradiation of the ultrashort pulsed laser beam LB or after the completion of the irradiation (field (c) of FIG. 2). In the way, the thin film F is removed by the width Wed from the end edge of the substrate W toward the center of rotation (left side in FIG. 2) to expose the surface of the substrate W.

When film peeling from the end edge portion of the surface of the substrate W is completed, the output of the ultrashort pulsed laser beam LB from the laser light source 5 is stopped. Thereafter, the irradiator 6 is moved to a retracted position distant from the substrate W and the rotation of the spin chuck 1 is stopped. Then, suction-holding of the substrate W by the spin chuck 1 is released and, further, the processed substrate W is carried from the spin chuck 1 to a next processing apparatus.

As described above, in the embodiment, the fluence of the ultrashort pulsed laser beam LB on the interface BF is set to be larger than the substrate processing threshold and smaller than the film processing threshold, and the ultrashort pulsed laser beam LB is irradiated to the interface BF via the thin film F. Thus, the substrate W is selectively processed in a laser irradiated portion of the interface BF, the bonding force between the substrate W and the thin film F is reduced, and the thin film F is peeled. In the way, a laser irradiated portion of the thin film F can be selectively peeled without causing the thin film F to physically or chemically react, i.e. by a dry process. Accordingly, it is possible to remove the thin film F without using a chemical solution and reduce production cost and environmental burden. For example, when the substrate W is a silicon substrate and the thin film F is a silicon oxide film (SiO₂), good film peeling is achieved if the fluence of the ultrashort pulsed laser beam LB on the interface BF is adjusted to be 215 [mJ/cm²] and the thin film F is peeled under the following conditions, i.e.

Specification of a femtosecond laser output from the above laser light source 5 is:
Wavelength: 800 [nm]
Pulse width: 250 [fs]
Average output: 1 [W]

Processing conditions:
Irradiated beam size: 3.5×0.01 [mm]
Circumferential speed of the substrate W: 2 [mm/s].
   That is, the substrate processing threshold of silicon is about 200 [mJ/cm²], whereas the film processing threshold of the silicon oxide film is about 4800 [mJ/cm²]. Thus, by setting the fluence of the ultrashort pulsed laser beam LB on the interface BF as described above, only the part WR of the substrate W is processed and the thin film F on the processing region WR is selectively peeled from the substrate W to expose the processing region WR.

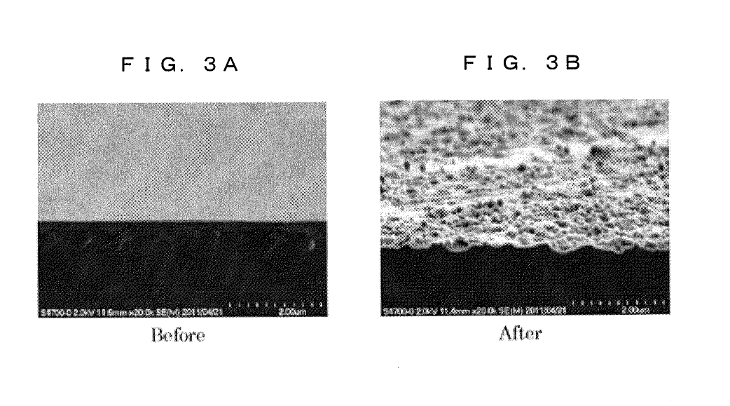

FIG. 3A is a picture showing a surface before a silicon oxide film on a silicon substrate was peeled, which surface was observed by a scanning microscope (magnification of 30×). FIG. 3B is a picture showing the surface after the silicon oxide film on the silicon substrate was peeled under the above film peeling conditions, which surface was observed by the scanning microscope (magnification of 20000×). As is clear from the picture, no burn mark or no debris is generated and a characteristic of the above film peeling to be a non-thermal process almost free from thermal influence can be confirmed.

Roughness of an area of the substrate surface exposed by peeling the thin film F by the above film peeling method, i.e. the processing region WR was measured by a stylus profilometer “Dektak” produced by Ulvac Equipment Sales, Inc. The measurement result was 15 [nm] or less. Further, it is confirmed from a roughness profile curve measured by the meter that the processing region WR was a relatively smooth surface and a good surface without burn marks, which are problematic in an ablation process by laser. Furthermore, debris (generation of peeled chips) is problematic in the ablation process by laser, but the generation of debris is not confirmed in the embodiment. The film peeling process can be performed with such excellent performance.

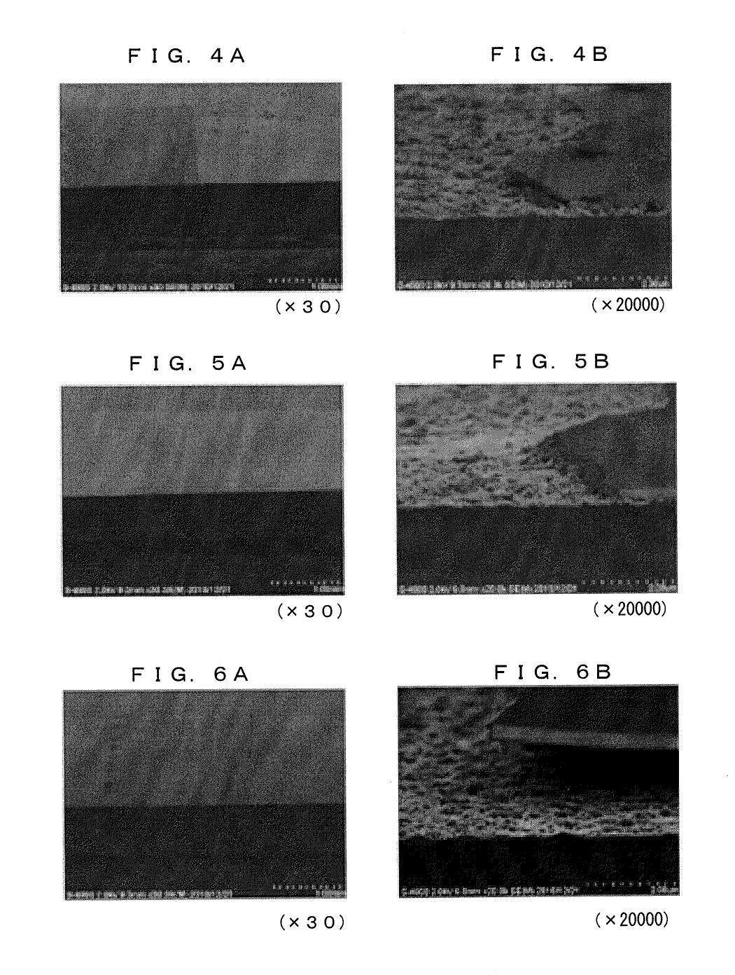

FIGS. 4A and 4B are pictures showing interfaces of a peeled portion and a non-removed portion when the silicon oxide film on the silicon substrate was peeled under the above film peeling conditions. FIG. 4A shows the interface observed by the scanning microscope (magnification of 30×). FIG. 4B shows the interface observed by the scanning microscope (magnification of 20000×). It is understood from FIG. 4A that the film was peeled in a desired shape. Further, it is understood from FIG. 4B that no debris was generated. Such good film peeling is not limited to the silicon oxide film and is applicable to other films. It is also understood that a silicon nitride film (SiN) on a silicon substrate as shown in FIGS. 5A and 5B and a silicon carbide film (SiC) on a silicon substrate as shown in FIGS. 6A and 6B can be peeled from the substrate without using a chemical solution by peeling under the above film peeling conditions.

Note that the present invention is not limited to the above embodiment and various changes other than the above one can be made without departing from the gist of the present invention. For example, although the thin film F is a single layer in the above embodiment, the same applies when a thin film has a multi-layer structure. That is, the fluence of the ultrashort pulsed laser beam LB on the interface BF only has to be set to be larger than the substrate processing threshold and smaller than a processing threshold fluence necessary to process each film of a multi-layer film by the ultrashort pulsed laser beam LB. In the case, by selectively processing the substrate W on the interface BF, the multi-layer film laminated on the processing region WR is integrally peeled from the substrate W.

Although the spot size of the ultrashort pulsed laser beam LB in the direction X is matched with the removal width Wed in the above embodiment, the following operation may be performed if the removal width Wed is relatively wide. For example, while the irradiator 6 is positioned at different positions in multiple stages in the direction X, the substrate W may be rotated at least one turn or more while the ultrashort pulsed laser beam LB is irradiated every time positioning is completed. The ultrashort pulsed laser beam LB may be continuously irradiated toward the rotating substrate W while the irradiator 6 is continuously moved in the direction X.

Although the film peeling apparatus and method according to the present invention are applied to an end processing technology for removing an end edge portion of a surface of a substrate, application of the present invention is not limited to the and the present invention is applicable to a film peeling technology in general for partly or entirely removing a film formed on a surface of a substrate. However, since the present invention utilizes a physical condition that the film processing threshold is larger than the substrate processing threshold, the physical condition needs to be satisfied. For example, the present invention can be effectively applied in many cases where an insulation film formed on a surface of a silicon substrate is peeled. The present invention can be effectively applied because a film processing threshold of an insulation film formed on a surface of a silicon substrate is at least 10 times or more as large as a substrate processing threshold in the field of technology for producing electronic components using silicon substrates.

Although the substrate W is unloaded from the film processing apparatus after the film peeling process is performed in the above embodiment, a film peeled state, i.e. a part of the substrate surface exposed by the peeling of the thin film F may be inspected after the film peeling process is completed. Further, a post-processing may be performed on the substrate W depending on the inspection result.

Although the laser beam LB having a femtosecond pulse width, i.e. the femtosecond laser beam LB is used as the ultrashort pulsed laser beam LB in the above embodiment, a laser beam LB having a picosecond pulse width, i.e. a picosecond laser beam LB may be used.

In the present invention, a mover for moving the irradiator relative to the substrate held by the holder may be further provided. The film can be peeled at a desired position by a relative movement of the irradiator.

A rotary drive for rotating the substrate held by the holder may be further provided, and the irradiator may be so positioned by the mover that the ultrashort pulsed laser beam is irradiated to a position distant from the center of rotation of the substrate in the radial direction of the substrate. This enables the film to be concentrically peeled about the center of rotation of the substrate. For example, by irradiating the ultrashort laser beam to a peripheral edge portion (bevel portion) of the surface of the rotating substrate, the film on the peripheral edge portion of the surface of the substrate can be peeled.

By further providing a controller for controlling the fluence of the ultrashort pulsed laser beam and the circumferential speed of the substrate, film peeling can be performed with high accuracy.

Note that a laser beam having a femtosecond or picosecond pulse width can be used as the ultrashort pulsed laser beam.

As described above, according to the invention, the substrate is processed and the film is peeled by irradiating the ultrashort pulsed laser beam to the interface between the substrate and the film at the above fluence via the film. This allows that the use of a chemical solution is made unnecessary and production cost and environmental burden can be reduced.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A film peeling apparatus, comprising:
a holder that holds the substrate having a film; and
an irradiator that irradiates an ultrashort pulsed laser beam to an interface between the substrate and the film via the film, thereby processing the substrate and peeling the film,
wherein the fluence of the ultrashort pulsed laser beam to be irradiated to the interface is larger than a processing threshold fluence necessary to process the substrate by the ultrashort pulsed laser beam and smaller than a processing threshold fluence necessary to process the film by the ultrashort pulsed laser beam.

2. The film peeling apparatus according to claim 1, further comprising a mover that moves the irradiator relative to the substrate held by the holder.

3. The film peeling apparatus according to claim 2, further comprising a rotary drive that rotates the substrate held by the holder, wherein:
the mover positions the irradiator such that the ultrashort pulsed laser beam is irradiated to a position distance from the center of rotation of the substrate in a radial direction of the substrate.

4. The film peeling apparatus according to claim 3, further comprising a controller that controls the fluence of the ultrashort pulsed laser beam and the circumferential speed of the substrate.

5. The film peeling apparatus according to claim 1, wherein the ultrashort pulsed laser beam has a femtosecond or picosecond pulse width.

6. A film peeling method for peeling a film formed on a substrate, the method comprising:
irradiating an ultrashort pulsed laser beam to an interface between the substrate and the film via the film,
wherein a fluence of the ultrashort pulsed laser beam is larger than a processing threshold fluence necessary to process the substrate by the ultrashort pulsed laser beam and smaller than a processing threshold fluence necessary to process the film by the ultrashort pulsed laser beam.
